(19) United States
(12) Patent Application Publication
(10) Pub. No.: US 2006/0099370 A1
(43) Pub. Date: May 11, 2006

(54) Adhesive attachment assembly and roofing system

(76) Inventor: Lawrence G. Glass, Highlands Ranch, CO (US)

Correspondence Address: JOHNS MANVILLE INTERNATIONAL, INC., 717 SEVENTEENTH STREET, DENVER, CO, 80202, US

(21) Appl. No.: 10/983,872

(22) Filed: Nov. 8, 2004

(51) Int. Cl. B32B 33/00

(52) U.S. Cl. 428/40.1; 428/66.6

(57) ABSTRACT

A roofing system uses a self-adhering adhesive attachment assembly for adhesively securing a roofing layer overlying the adhesive attachment assembly to the roofing substrate (e.g. a roof deck). The assembly includes an insulation plate for receiving one or more mechanical fasteners there through to secure the adhesive attachment assembly to the roofing substrate; a self-adhering adhesive layer overlying a top major surface of the insulation plate; and a release liner overlying the self-adhering adhesive layer. After the assembly is secured to a roofing substrate, the release liner is removed from the self-adhering adhesive layer to adhesively secure the overlying layer to the substrate.

### BACKGROUND OF THE INVENTION

The subject invention relates to a roofing system and to self-adhering adhesive attachment assemblies used in the roofing system to secure one or more roofing layers, such as roof insulation layers, to a roof deck and/or other roof substrate.

In most current roofing systems where multiple layers of roof insulation are installed over a roof deck, all of the roof insulation layers of the roofing system must be secured together. Typically, the roof insulation layers of these roofing systems are either secured together with mechanical fasteners or bonded together with a layer of cold applied adhesive. The use of mechanical fasteners to secure multiple roof insulation layers of the roofing system together creates thermal shorts through the insulation layers and thus the roofing system to degrade the insulating properties of the roofing system. The use of a cold applied adhesive layer to bond the roof insulation layers together, requires an extra installation step, the application of the adhesive layer to the underlying insulation layer, and increases material costs for the roofing system.

Current industry standards, e.g. Factory Mutual Global Standards, for roof construction require that any roof insulation layer directly applied to a metal roof deck be attached to the metal roof deck with a mechanical fastener that penetrates through the roof insulation layer into the metal roof deck. Direct adhesive attachment of such a roof insulation layer to the metal roof deck is not approved. Thus, even though the adhesive attachment of such a roof insulation layer to a metal roof deck could be a more effective method of attachment and would permit the factory prefabrication of a multi-layer roofing system insulation panel for use on metal roof decks (e.g. a multi-layer panel including an insulation layer and a top waterproofing membrane layer) current roofing industry practices and systems do not permit such innovations.

The roofing system and the self-adhering adhesive attachment assemblies of the roofing system of the subject invention provide an effective, economical, easy to use, solution to the problems associated with current roofing systems discussed above.

### SUMMARY OF THE INVENTION

The self-adhering adhesive attachment assemblies of the subject invention that are used in the roofing system of the subject invention include: an insulation plate for receiving a mechanical fastener there through to secure the adhesive attachment assembly to a roofing substrate; a self-adhering adhesive layer overlying a top major surface of the insulation plate; and a release liner overlying the self-adhering adhesive layer. When a self-adhering adhesive attachment assembly of the subject invention is secured to a roofing substrate (e.g. a metal roof deck) by a mechanical fastener, the release liner is removed from the self-adhering adhesive layer of the assembly to adhesively bond a roofing layer overlying the self-adhering adhesive attachment assembly to the roofing substrate. The self-adhering adhesive attachment assembly of the subject invention may also have a self-adhering adhesive layer, overlaid by a release liner, underlying the insulation plate for bonding the attachment assembly to an underlying roofing substrate.

In this specification and claims, a “self-adhering adhesive” is an adhesive that, primarily with the application of pressure, forms a bond with a surface of another component without the need to use heat, flame, or additional adhesive material.

The self-adhering adhesive attachment assembly of the subject invention may be a generally disk-shape attachment assembly with a generally disk-shape insulation plate or a batten-shape attachment assembly with a batten-shape insulation plate. Preferably, the batten-shape self-adhering adhesive attachment assembly is flexible and can be packaged, stored, shipped, and handled in roll form prior to installation.

Current roof insulation plates, which have stiffening ribs, have the stiffening ribs located on the bottom side of the insulation plates. When these insulation plates are installed, the ribs can penetrate and damage the underlying insulation layer being secured to a roofing substrate by the insulation plates. Unlike current roof insulation plates, the preferred insulation plate of the generally disk-shaped self-adhering adhesive attachment assembly of the subject invention has stiffening ribs on the top side of the insulation plate and the self-adhering adhesive layer that overlies the top surface of the plate and encases the stiffening ribs. With this structure the self-adhering adhesive layer pads the stiffening ribs on the insulation plate and forms a generally flat upper surface on the generally disk-shaped self-adhering adhesive attachment assembly so that the ribs do not damage the insulation or other roofing layer overlying and being secured to a roofing substrate by the self-adhering adhesive attachment assembly.

Preferably, the generally disk-shape self-adhering adhesive attachment assembly of the subject invention has a preformed fastener-receiving hole therein through which the threaded or unthreaded shank portion of a mechanical fastener passes to secure the assembly to a roofing substrate. Preferably, the batten-shape self-adhering adhesive attachment assembly of the subject invention has a series of longitudinally spaced apart fastener-receiving holes therein through which the threaded or unthreaded shank portions of mechanical fasteners pass to secure the assembly to a roofing substrate. The fastener-receiving holes in the self-adhering adhesive attachment assemblies of the subject invention may be reinforced and preferably are free of adhesive and release liners so that the threaded or unthreaded shank portions of mechanical fasteners used to secure the assemblies to roofing substrates can be easily and quickly threaded or driven through the holes. The self-adhering adhesive layers overlying the top major surfaces of the insulation plates of the self-adhering adhesive attachment assemblies are provided with recesses surrounding the fastener-receiving holes in the insulation plates to accommodate the heads of the mechanical fasteners and/or the portions of the self-adhering adhesive layers surrounding the fastener-receiving holes in the insulation plates are sufficiently pliable to yield and accommodate the heads of the mechanical fasteners so that the heads of the mechanical fasteners do not protrude above the top surfaces of the self-adhering adhesive layers of the attachment assemblies to form thermal shorts between roofing system layers.

Both the generally disk-shape self-adhering adhesive attachment assembly and the batten-shape self-adhering adhesive attachment assembly can be used to mechanically secure a first roofing layer (e.g. an insulation layer) to a roof deck or other roofing substrate and then adhesively bond a second roofing layer (e.g. an insulation layer or waterproofing membrane layer) that overlies the self-adhering attachment assembly to the first roofing layer and the roofing substrate. The batten-shape self-adhering adhesive attachment assembly of the subject invention is also specifically designed to be secured directly by mechanical fasteners to a metal roof deck substrate to provide a first insulation layer secured to the metal roof deck in accordance with industry standards that can be used to adhesively bond a overlying roofing layer (e.g. insulation layer) to the metal roof deck substrate.

It is also contemplated that insulation boards or roofing panels consisting of insulation boards with an integral factory laminated waterproofing membrane overlying the batten-shape self-adhering adhesive attachment assemblies of a roofing system of the subject invention could also have self-adhering adhesive strips, overlaid by release liners, that with the release liners removed are bonded directly to the self-adhering adhesive layers of the batten-shape self-adhering attachment assemblies.

### BRIEF DESCRIPTION OF THE DRAWINGS

FIG. 1 is a schematic perspective view of a first embodiment of a generally disk-shape self-adhering adhesive attachment assembly of the subject invention.

FIG. 2 is a schematic top view of the insulation plate of the generally disk-shape self-adhering adhesive attachment assemblies of FIGS. 1 and 5.

FIG. 3 is a schematic transverse cross section of the generally disk-shape self-adhering adhesive attachment assembly of FIG. 1 taken substantially along lines 3-3 of FIG. 1.

FIG. 4 is a schematic transverse cross section of the generally disk-shape self-adhering adhesive attachment assembly of FIG. 1 securing a roofing layer to a roofing substrate.

FIG. 5 is a schematic perspective view of a second embodiment of the generally disk-shape self-adhering adhesive attachment assembly of the subject invention

FIG. 6 is a schematic transverse cross section of the generally disk-shape self-adhering adhesive attachment assembly of FIG. 5 taken substantially along lines 6-6 of FIG. 5.

FIG. 7 is a schematic transverse cross section of the generally disk-shape self-adhering adhesive attachment assembly of FIG. 5 securing a roofing layer to a roofing substrate.

FIG. 8 is a schematic side view of the generally disk-shape self-adhering adhesive attachment assemblies of FIGS. 1 and 5 that includes a bottom self-adhering adhesive layer and release liner.

FIG. 9 is a schematic cross section through a roofing system utilizing generally disk-shape self-adhering adhesive attachment assemblies of FIG. 1, 5 or 8 to mechanically secure a first roofing layer and adhesively secure a second overlying roofing layer to the every second course of a corrugated metal roof deck.

FIG. 10 is a schematic cross section of the roofing system of FIG. 9 taken substantially along lines 10-10 of FIG. 9.

FIG. 11 is a partial schematic perspective view of a first embodiment of the batten-shape self-adhering adhesive attachment assembly of the subject invention.

FIG. 12 is a schematic transverse cross section of the batten-shape self-adhering adhesive attachment assembly of FIG. 11 taken substantially along lines 12-12 of FIG. 11.

FIG. 13 is a schematic transverse cross section of the batten-shape self-adhering adhesive attachment assembly of FIG. 11 secured to a roofing substrate.

FIG. 14 is a partial schematic perspective view of a second embodiment of the batten-shape self-adhering adhesive attachment assembly of the subject invention.

FIG. 15 is a schematic transverse cross section of the batten-shape self-adhering adhesive attachment assembly of FIG. 14 taken substantially along lines 15-15 of FIG. 14.

FIG. 16 is a schematic transverse cross section of the batten-shape self-adhering adhesive attachment assembly of FIG. 14 secured to a roofing substrate.

FIG. 17 is an end view of the batten-shape self-adhering adhesive attachment assemblies of FIGS. 11 and 14 that include a bottom self-adhering adhesive layer and release liner.

FIG. 18 is a schematic cross section through a roofing system utilizing batten-shape self-adhering adhesive attachment assemblies of FIG. 11, 14, or 17 to mechanically secure a first roofing layer and adhesively secure a second overlying roofing layer to the every second course of a corrugated metal roof deck.

FIG. 19 is a schematic cross section of the roofing system of FIG. 18 taken substantially along lines 19-19 of FIG. 18.

FIG. 20 is a schematic cross section through a roofing system utilizing batten-shape self-adhering adhesive attachment assemblies of FIG. 11, 14, or 17 to adhesively secure an overlying roofing layer to the every second course of a corrugated metal roof deck.

FIG. 21 is a schematic cross section of the roofing system of FIG. 20 taken substantially along lines 21-21 of FIG. 20.

FIG. 22 is a schematic cross section through a roofing system utilizing batten-shape self-adhering adhesive attachment assemblies of FIG. 11, 14, or 17 to adhesively secure an overlying roofing layer of insulation boards to the every second course of a corrugated metal roof deck wherein the insulation boards have adhesive strips on the bottom major surfaces of the insulation boards bonded to the assemblies.

### DESCRIPTION OF THE PREFERRED EMBODIMENTS

FIGS. 1 to 4 show a first embodiment 20 of the generally disk-shape self-adhering adhesive attachment assembly of the subject invention. The self-adhering adhesive attachment assembly 20 includes: an insulation plate 22 through which a threaded or unthreaded shank of a mechanical fastener passes to secure the adhesive attachment assembly to a roofing substrate; a self-adhering adhesive layer 24 overlying a top major surface of the insulation plate 22; and a release liner 26 overlying the self-adhering adhesive layer 24. The self-adhering adhesive attachment assembly 20 is typically used to mechanically secure an insulation layer to a roofing substrate (e.g. a metal roof deck) and then, with the release liner 26 removed from the self-adhering adhesive layer 24 of the assembly, to adhesively bond a roofing layer overlying the self-adhering adhesive attachment assembly 20 to the roofing substrate.

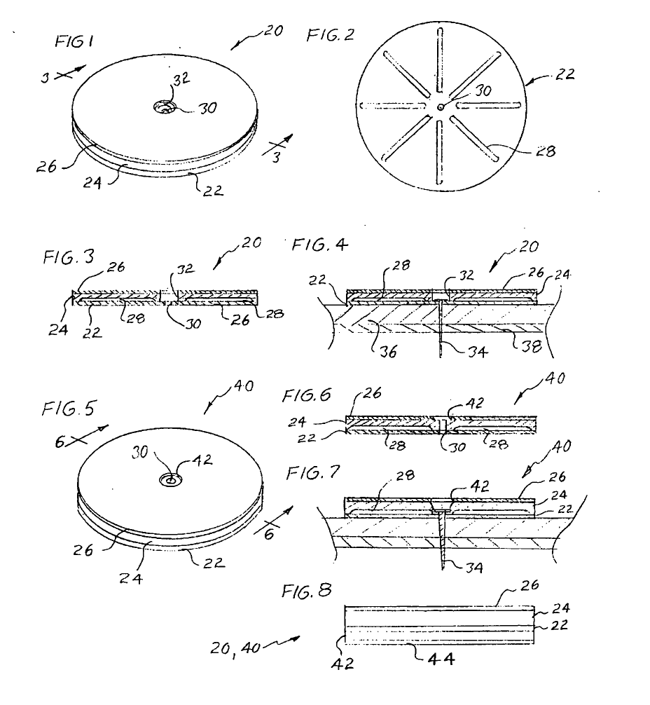

Preferably, the insulation plate 22 is made of a durable polymer-based material, such as but not limited to a polyethylene-based or polypropylene-based material. However, the insulation plate 22 may also be made from a corrosion-resistant metal such as but not limited to galvanized steel. Preferably, the insulation plate 22 has a plurality of stiffening ribs 28 on the upper major surface of the insulation plate, such as but not limited to the radially extending stiffening ribs 28 shown in FIG. 2, to stiffen the plate. The insulation plate 22 is provided with a centrally located fastener-receiving hole 30 for receiving the threaded or unthreaded shank portion of a mechanical fastener that passes through the self-adhering adhesive attachment assembly 20 to secure the assembly to a roofing substrate. The inner ends of the stiffening ribs 28 are typically spaced radially outward from the fastener-receiving hole 30 so that the head of a mechanical fastener securing the self-adhering adhesive attachment assembly 20 to a roofing substrate rests on a flat annular surface of the insulation plate surrounding the fastener-receiving hole 30. The fastener-receiving hole 30 of the insulation plate 22 may have a grommet made of metal or other firm material secured thereto. The grommet would reinforce the insulation plate adjacent the fastener-receiving hole 30 and provide the self-adhering adhesive attachment assembly 20 with greater pull through strength to resist fastener pull through when the assembly is subjected to in service stresses such as wind uplift stresses. As an alternative to the use of a grommet, it is also contemplated that a polymer-based material forming the portion of the insulation plate 22 immediately surrounding the fastener-receiving hole 30 may have a greater density or be otherwise strengthened relative to other portions of the insulation plate 22 to reinforce the insulation plate 22 adjacent the fastener-receiving hole 30 and provide the self-adhering adhesive attachment assembly 20 with a desired amount of pull through strength.

The self-adhering adhesive layer 24 may be modified bitumen or other self-adhering adhesive suitable for such applications. The self-adhering adhesive layer 24 may be formed on the top major surface of the insulation plate 22 by using an adhesive tape with top and bottom self-adhering adhesive layers overlaid by top and bottom release liners. The bottom release liner is removed and the tape is applied and adhered to the top surface of the insulation plate with the top release liner still overlying the top self-adhering adhesive layer. Innovative Adhesives Company of Kansas City, Mo. sells a two-sided self-adhering adhesive tape of this type. The self-adhering adhesive layer 24 overlies and is coextensive with or substantially coextensive with the top major surface of the insulation plate 22. The self-adhering adhesive layer 24 has a thickness greater than the height of the stiffening ribs 28 and encases the stiffening ribs 28. With its greater thickness, the self-adhering adhesive layer 24 pads the stiffening ribs 28 and provides the self-adhering adhesive attachment assembly 20 with an upper surface that is flat or substantially flat so that the adhesive attachment assembly 20 will not damage a roofing insulation layer or membrane layer overlying and being secured to a roofing substrate by the adhesive attachment assembly 20.

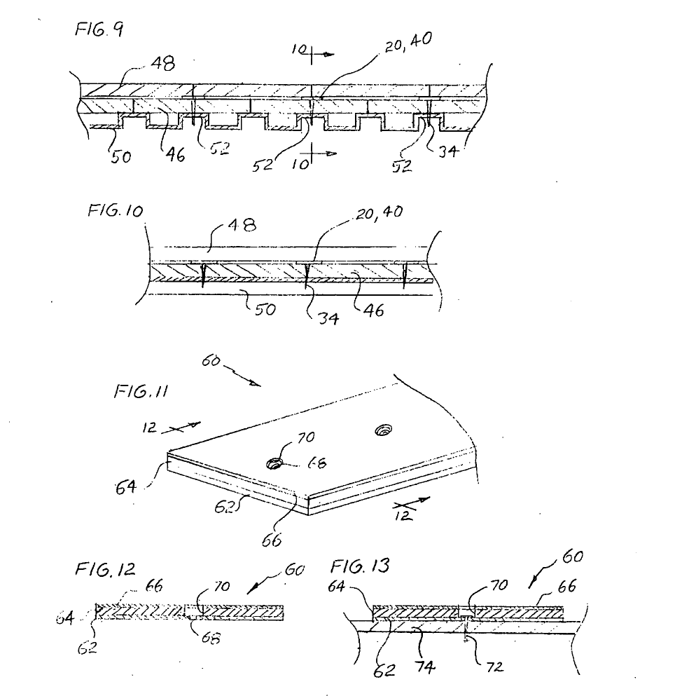

The self-adhering adhesive layer 24 does not overlie the fastener-receiving hole 30 of the insulation plate 22 so that the fastener-receiving hole 30 of the insulation plate 22 is free or clear of adhesive. In the self-adhering adhesive attachment assembly 20, there is a recess 32 in the self-adhering adhesive layer 24 surrounding the fastener-receiving hole 30 in the insulation plate 22 for accommodating the head of a mechanical fastener securing the assembly 20 to a roofing substrate. As shown in FIG. 4, the recess 32 accommodates the head of a mechanical fastener 34 securing the self-adhering adhesive attachment assembly 20 and an insulation layer 36 to a roofing substrate 38 so that the top of the mechanical fastener head does not protrude above the top surface of the self-adhering adhesive layer 24 and preferably, so that the top of the mechanical fastener head is below the top surface of the self-adhering adhesive layer 24. With this structure, the mechanical fastener 34 is isolated by the self-adhering adhesive layer 24 from a roofing layer overlying and bonded by the self-adhering adhesive attachment assembly 20 to the roofing substrate 38 and does not create a thermal short between such an overlying layer and the underlying roofing layers 36 and 38.

The release liner 26 is made of a silicone treated paper or other conventional release liner sheet material. The release liner 26 overlies and is coextensive with or substantially coextensive with the top major surface of self-adhering adhesive layer 24 of the self-adhering adhesive attachment assembly 20. The release liner 26 keeps the self-adhering adhesive attachment assembly 20 from sticking to other assemblies or objects prior to use and protects the self-adhering adhesive layer 24 from degradation, such as but not limited to the accumulation of dust and/or other non-adhesive materials on the surface of the adhesive layer, during storage, shipment, and handling. The release liner 26 is typically peeled off of the top surface of the self-adhering adhesive layer 24 immediately prior to the application and bonding of an overlying roofing layer to the top major surface of self-adhering adhesive layer 24.

FIGS. 5 to 7 show a second embodiment 40 of the generally disk-shape self-adhering adhesive attachment assembly of the subject invention. Except as set forth below, the self-adhering adhesive attachment assembly 40 is the same as the self-adhering adhesive attachment assembly 20 and includes: the insulation plate 22 through which the threaded or unthreaded shank portion of a mechanical fastener passes to secure the adhesive attachment assembly to a roofing substrate; the self-adhering adhesive layer 24 overlying a top major surface of the insulation plate 22; and the release liner 26 overlying the self-adhering adhesive layer 24.

As shown in FIGS. 5 to 7, the self-adhering adhesive layer overlies and is coextensive with or substantially coextensive with the top major surface of the insulation plate 22. The self-adhering adhesive layer 24 has a thickness greater than the height of the stiffening ribs 28 and encases the stiffening ribs 28. With its greater thickness, the self-adhering adhesive layer 24 pads the stiffening ribs 28 and provides the self-adhering adhesive attachment assembly 40 with an upper surface that is flat or substantially flat so that the adhesive attachment assembly 40 will not damage a roofing insulation layer or membrane layer overlying and being secured to a roofing substrate by the adhesive attachment assembly.

The fastener-receiving hole 30 in the insulation plate 22 also passes through the self-adhering adhesive layer 24 so that the fastener-receiving hole 30 of the self-adhering adhesive attachment assembly 40 is free or clear of adhesive. The portion of the self-adhering adhesive layer 24 immediately surrounding the fastener-receiving hole 30 passing through the insulation plate 22 and the self-adhering adhesive layer 24 is sufficiently pliable to deform and accommodate the head of a mechanical fastener driven or threaded through the adhesive attachment assembly 40 to secure the adhesive attachment assembly 40 to a roofing substrate. As shown in FIG. 7, the self-adhering adhesive layer 24 deforms and accommodates the head of a mechanical fastener 34 securing the self-adhering adhesive attachment assembly 40 and an insulation layer 36 to a roofing substrate 38 so that the top of the mechanical fastener head does not protrude above the top surface of the self-adhering adhesive layer 24 and preferably, so that the top of the mechanical fastener head is below the top surface of the self-adhering adhesive layer 24. With this structure, the mechanical fastener 34 is isolated by the self-adhering adhesive layer 24 from a roofing layer overlying and bonded by the self-adhering adhesive attachment assembly 40 to the roofing substrate 38 and does not create a thermal short between such an overlying layer and the underlying roofing layers 36 and 38.

As shown in FIGS. 5 to 7, the release liner 26 overlies and is coextensive with or substantially coextensive with the top major surface of self-adhering adhesive layer 24 of the self-adhering adhesive attachment assembly 40. As shown, the opening in the release liner 26 has an inner annular edge 42 which is spaced radially outward from the fastener-receiving hole 30 passing through the adhesive layer 24 and the insulation plate 22 a distance greater than the diameter of the fastener head so that the release liner does not overlie the annular portion of self-adhering adhesive layer 24 adjacent the fastener-receiving hole 30. Thus, the head of the mechanical fastener 34 securing the self-adhering adhesive attachment assembly 40 to a roofing substrate can pass through the release liner 26 without engaging the release liner and subsequently, the release liner can be easily peeled off the top surface of the self-adhering adhesive layer 24. As an alternative, should it be desirable to have the release liner 26 extend inward to surround the fastener-receiving hole 30, the release liner 26 may have a ring of perforations spaced radially outward from the fastener-receiving hole 30 a distance greater than the diameter of the fastener head to permit the release liner 26 to readily separate along the perforated ring when the release liner 26 is peeled off of the top surface of the self-adhering layer 24.

As shown in FIG. 8, the generally disk-shape self-adhering adhesive attachment assemblies 20 and 40 may also have a self-adhering adhesive layer 42, overlaid by a release liner 44, underlying the insulation plate 22 for bonding the self-adhering adhesive attachment assemblies 20 and 40 to an underlying roofing layer. The generally disk-shape self-adhering adhesive attachment assemblies are typically between about 3 inches and about 12 inches in diameter and preferably between about 6 and 12 inches in diameter. While, as shown, the generally disk-shape self-adhering adhesive attachment assemblies 20 and 40 are circular, the generally disk-shape self-adhering adhesive attachment assemblies 20 and 40 may have other shapes such as but not limited to oval, square, and rectangular shapes with surface areas approximating the surface areas of the circular disk embodiments described in this paragraph.

FIGS. 9 and 10 show a series of the self-adhering adhesive attachment assemblies 20 or 40 securing first and second roofing insulation layers made up of roof insulation boards 46 and 48 to a corrugated metal roof deck 50. As shown, the mechanical fasteners 34 (e.g. screw fasteners) pass down through the self-adhering adhesive attachment assemblies 20 or 40, the roof insulation boards 46 of the first roof insulation layer, and every second course 52 of the corrugated metal deck 50 to mechanically secure the roof insulation boards 46 to the roof deck. The roof insulation boards 48 of the second roof insulation layer are bonded to the self-adhering adhesive attachment assemblies 20 or 40 and through the self-adhering attachment assemblies to the roof insulation boards 46 of the first roof insulation layer and the metal roof deck 50.

FIGS. 11 to 13 show a first embodiment 60 of the batten-shape self-adhering adhesive attachment assembly of the subject invention. The self-adhering adhesive attachment assembly 60 includes: an insulation plate 62 through which the threaded or unthreaded shanks of mechanical fasteners pass to secure the adhesive attachment assembly to a roofing substrate; a self-adhering adhesive layer 64 overlying a top major surface of the insulation plate 62; and a release liner 66 overlying the self-adhering adhesive layer 64. Typically, the self-adhering adhesive attachment assembly 60 is secured by mechanical fasteners directly to a roofing substrate (e.g. a metal roof deck) and then, with the release liner 66 removed from the self-adhering adhesive layer 64 of the assembly, the assembly is used to adhesively bond a roofing layer overlying the self-adhering adhesive attachment assembly 60 to the roofing substrate. However, the self-adhering adhesive attachment assembly 60 also may be used to mechanically secure an insulation layer to a roofing substrate (e.g. a metal roof deck) and then, with the release liner 66 removed from the self-adhering adhesive layer 64 of the assembly, to adhesively bond a roofing layer overlying the self-adhering adhesive attachment assembly 60 to the roofing substrate. Preferably, the batten-shape self-adhering adhesive attachment assembly 60 is flexible and can be packaged, stored, shipped, and handled in roll form prior to installation.

Preferably, the insulation plate 62 is made of a durable and flexible polymer-based material, such as but not limited to a polyethylene-based or polypropylene-based material. However, the insulation plate 62 may also be made from a corrosion-resistant metal such as but not limited to galvanized steel. Preferably, the insulation plate 62 is provided with a longitudinally extending series of centrally located spaced-apart holes 68 for receiving the threaded or unthreaded shank portions of mechanical fasteners that pass through the self-adhering adhesive attachment assembly 60 to secure the assembly to a roofing substrate. The fastener-receiving holes 68 of the insulation plate 62 may have grommets made of a metal or other firm material secured thereto. The grommets would reinforce the insulation plate 62 adjacent the fastener-receiving holes 68 and provide the self-adhering adhesive attachment assembly 60 with greater pull through strength to resist fastener pull through when the assembly is subjected to in service stresses such as wind uplift stresses. As an alternative to the use of grommets, it is also contemplated that a polymer-based material forming the portions of the insulation plate 62 immediately surrounding the fastener-receiving holes 68 may have a greater density or be otherwise strengthened relative to other portions of the insulation plate 62 to reinforce the insulation plate 62 adjacent the fastener-receiving holes 68 and provide the self-adhering adhesive attachment assembly 60 with a desired amount of pull through strength.

The self-adhering adhesive layer 64 may be modified bitumen or other self-adhering adhesive suitable for such applications. The self-adhering adhesive layer 64 may be formed on the top major surface of the insulation plate 62 by using an adhesive tape with top and bottom self-adhering adhesive layers overlaid by top and bottom release liners. The bottom release liner is removed and the tape is applied and adhered to the top surface of the insulation plate with the top release liner still overlying the top self-adhering adhesive layer. Innovative Adhesives Company of Kansas City, Mo. sells a two-sided self-adhering adhesive tape of this type. The self-adhering adhesive layer 64 overlies and is coextensive with or substantially coextensive with the top major surface of the insulation plate 62.

The self-adhering adhesive layer 64 does not overlie the fastener-receiving holes 68 of the insulation plate 62 so that the fastener-receiving holes 68 of the insulation plate 62 are free or clear of adhesive. In the self-adhering adhesive attachment assembly 60, there are recesses 70 in the self-adhering adhesive layer 64 surrounding the fastener-receiving holes 68 in the insulation plate 62 for accommodating the heads of mechanical fasteners securing the assembly 60 to a roofing substrate. As shown in FIG. 13, the recesses 70 accommodate the heads of mechanical fasteners 72 securing the self-adhering adhesive attachment assembly 60 to a roofing substrate 74 so that the tops of the mechanical fastener heads do not protrude above the top surface of the self-adhering adhesive layer 64 and preferably, so that the tops of the mechanical fastener heads are below the top surface of the self-adhering adhesive layer 64. With this structure, the mechanical fasteners 72 are isolated by the self-adhering adhesive layer 64 from a roofing layer overlying and bonded by the self-adhering adhesive attachment assembly 60 to the roofing substrate 74 and do not create a thermal short between such an overlying layer and the underlying roofing layer 74.

The release liner 66 is made of a silicone treated paper or other conventional release liner sheet material. The release liner 66 overlies and is coextensive with or substantially coextensive with the top major surface of self-adhering adhesive layer 64 of the self-adhering adhesive attachment assembly 60. The release liner 66 keeps the self-adhering adhesive attachment assembly 60 from sticking to other assemblies or objects prior to use and protects the self-adhering adhesive layer 64 from degradation, such as but not limited to the accumulation of dust and/or other non-adhesive materials on the surface of the adhesive layer, during storage, shipment, and handling. The release liner 66 is typically peeled off the top surface of the self-adhering adhesive layer 64 immediately prior to the application and bonding of an overlying roofing layer to the top major surface of self-adhering adhesive layer 64.

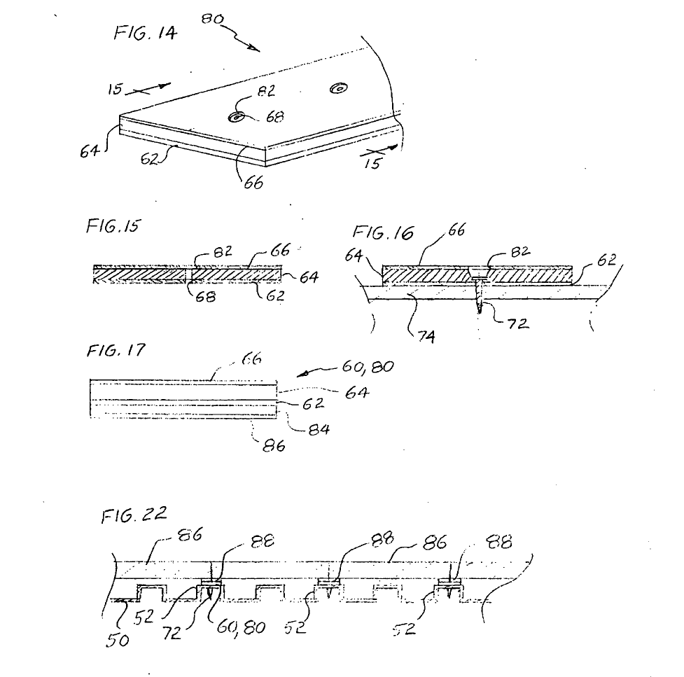

FIGS. 14 to 16 show a second embodiment 80 of the batten-shape self-adhering adhesive attachment assembly of the subject invention. Except as set forth below, the self-adhering adhesive attachment assembly 80 is the same as the self-adhering adhesive attachment assembly 60 and includes: the insulation plate 62 through which the threaded or unthreaded shank portions of mechanical fasteners pass to secure the adhesive attachment assembly to a roofing substrate; the self-adhering adhesive layer 64 overlying a top major surface of the insulation plate 62; and the release liner 66 overlying the self-adhering adhesive layer 64.

As shown in FIGS. 14 to 16, the self-adhering adhesive layer 64 overlies and is coextensive with or substantially coextensive with the top major surface of the insulation plate 62. The fastener-receiving hole 68 in the insulation plate 62 also passes through the self-adhering adhesive layer 64 so that the fastener-receiving hole 68 of the self-adhering adhesive attachment assembly 80 is free or clear of adhesive. The portions of the self-adhering adhesive layer 64 immediately surrounding the fastener-receiving holes 68 passing through the insulation plate 62 and the self-adhering adhesive layer 64 are sufficiently pliable to deform and accommodate the heads of mechanical fasteners driven or threaded through the adhesive attachment assembly 80 to secure the adhesive attachment assembly 80 to a roofing substrate. As shown in FIG. 16, the self-adhering adhesive layer 64 deforms and accommodates the heads of mechanical fasteners 72 securing the self-adhering adhesive attachment assembly 80 to a roofing substrate 74 so that the tops of the mechanical fastener heads do not protrude above the top surface of the self-adhering adhesive layer 64 and preferably, so that the tops of the mechanical fastener heads are below the top surface of the self-adhering adhesive layer 64. With this structure, the mechanical fasteners 72 are isolated by the self-adhering adhesive layer 64 from a roofing layer overlying and bonded by the self-adhering adhesive attachment assembly 80 to the roofing substrate 74 and do not create a thermal short between such an overlying layer and the underlying roofing layer 74.

As shown in FIGS. 14 to 16, the release liner 66 overlies and is coextensive with or substantially coextensive with the top major surface of self-adhering adhesive layer 64 of the self-adhering adhesive attachment assembly 80. As shown, the openings in the release liner 66 have inner annular edges 82 which are spaced radially outward from the fastener-receiving holes 68 passing through the adhesive layer 64 and the insulation plate 62 a distance greater than the diameter of the fastener heads so that the release liner does not overlie the annular portions of self-adhering adhesive layer 64 adjacent the fastener-receiving holes 68. Thus, the heads of the mechanical fasteners 72 securing the self-adhering adhesive attachment assembly 80 to a roofing substrate can pass through the release liner 66 without engaging the release liner and subsequently, the release liner can be easily peeled off the top surface of the self-adhering adhesive layer 64. As an alternative, should it be desirable to have the release liner 26 extend inward to surround the fastener-receiving holes 68, the release liner 26 may have rings of perforations spaced radially outward from the fastener-receiving holes 68 a distance greater than the diameter of the fastener heads to permit the release liner 26 to readily separate along the perforated ring when the release liner 26 is peeled off of the top surface of the self-adhering layer 24.

As shown in FIG. 17, the batten-shape self-adhering adhesive attachment assemblies 60 and 80 may also have a self-adhering adhesive layer 84, overlaid by a release liner 86, underlying the insulation plate 62 for bonding the self-adhering adhesive attachment assemblies 60 and 80 to an underlying roofing layer. The batten-shape self-adhering adhesive attachment assemblies 60 and 80 are typically between about 2.5 to about 3 inches wide by at least 8 feet in length. Preferably, the self-adhering adhesive attachment assemblies 60 and 80 are packaged, shipped, stored, and handled in longer length roll form (e.g. lengths of 50 to 100 feet or more). Preferably, the fastener-receiving holes 68 are located on 6-inch centers along the length of the batten-shape self-adhering adhesive attachment assemblies 60 and 80.

FIGS. 18 and 19 show a series of the self-adhering adhesive attachment assemblies 60 or 80 securing first and second roofing insulation layers made up of roof insulation boards 46 and 48 to a corrugated metal roof deck 50. As shown, the mechanical fasteners 72 (e.g. screw fasteners) pass down through the self-adhering adhesive attachment assemblies 60 or 80, the roof insulation boards 46 of the first roof insulation layer, and every second course 52 of the corrugated metal deck 50 to mechanically secure the roof insulation boards 46 to the roof deck. Depending on the requirements of a particular installation, the mechanical fasteners 72 securing the assemblies to the deck 50 may pass through each fastener-receiving hole 68 in the series of fastener-receiving holes or only selected fastener-receiving holes 68 in the series of fastener-receiving holes (e.g. every second fastener-receiving hole). The roof insulation boards 48 of the second roof insulation layer are bonded to the self-adhering adhesive attachment assemblies 60 or 80 and through the self-adhering attachment assemblies to the roof insulation boards 46 of the first roof insulation layer and the metal roof deck 50.

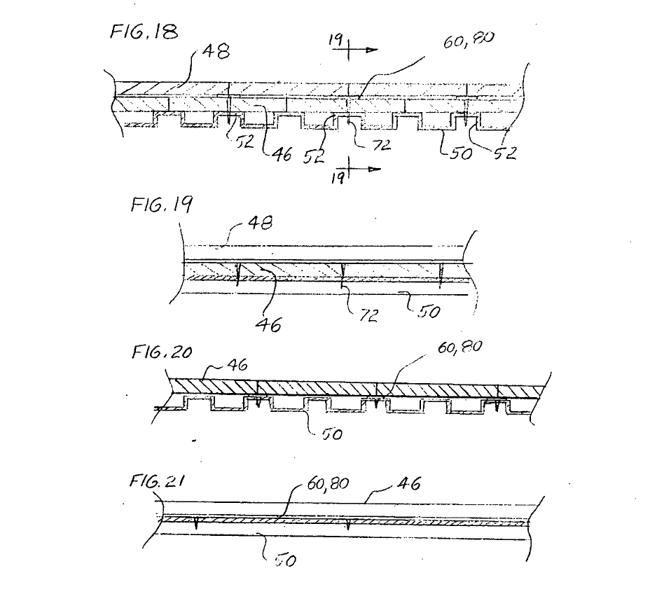

FIGS. 20 and 21 show a series of the self-adhering adhesive attachment assemblies 60 or 80 securing a roof insulation layer made up of roof insulation boards 46 to a corrugated metal roof deck 50. As shown, the mechanical fasteners 72 (e.g. screw fasteners) pass down through the self-adhering adhesive attachment assemblies 60 or 80 into every second course 52 of the corrugated metal deck 50 to mechanically secure the self-adhering adhesive attachment assemblies to the roof deck. Depending on the requirements of a particular installation, the mechanical fasteners 72 securing the assemblies to the deck 50 may pass through each fastener-receiving hole 68 in the series of fastener-receiving holes or only selected fastener-receiving holes 68 in the series of fastener-receiving holes (e.g. every second fastener-receiving hole). The roof insulation boards 46 of the roof insulation layer are bonded to the self-adhering adhesive attachment assemblies 60 or 80 and through the self-adhering attachment assemblies to the metal roof deck 50.

FIG. 22 shows a series of the self-adhering adhesive attachment assemblies 60 or 80 securing a roof insulation layer made up of roof insulation boards 86 to a corrugated metal roof deck 50. As shown, the mechanical fasteners 72 (e.g. screw fasteners) pass down through the self-adhering adhesive attachment assemblies 60 or 80 into every second course 52 of the corrugated metal deck 50 to mechanically secure the self-adhering adhesive attachment assemblies to the roof deck. The roof insulation boards 86 of the roof insulation layer have self-adhering adhesive strips 88 on the bottom major surfaces of the insulation boards. The self-adhering adhesive strips 88 are located on the bottom major surfaces of the insulation boards 86 so that the self-adhering adhesive strips 88 are aligned with the self-adhering adhesive attachment assemblies 60 or 80; are bonded to the self-adhering adhesive attachment assemblies 60 or 80; and through the self-adhering attachment assemblies are bonded to the metal roof deck 50. The self-adhering adhesive strips 88 may be formed on the bottom major surfaces of the insulation boards 86 by using an adhesive tape with top and bottom self-adhering adhesive layers overlaid by top and bottom release liners. The top release liners are removed and the tapes are applied and adhered to the bottom major surfaces of the insulation boards with the bottom release liner overlying the bottom self-adhering adhesive layer of the tape until the insulation boards are installed. Innovative Adhesives Company of Kansas City, Mo. sells a two-sided self-adhering adhesive tape of this type.

In describing the invention, certain embodiments have been used to illustrate the invention and the practices thereof. However, the invention is not limited to these specific embodiments as other embodiments and modifications within the spirit of the invention will readily occur to those skilled in the art on reading this specification. Thus, the invention is not intended to be limited to the specific embodiments disclosed, but is to be limited only by the claims appended hereto.

What is claimed is:

1. A self-adhering adhesive attachment assembly for a roofing system, comprising:
an insulation plate for receiving a mechanical fastener there through to secure the adhesive attachment assembly to a roofing substrate; a self-adhering adhesive layer overlying a top major surface of the insulation plate; and a release liner overlying the self-adhering adhesive layer whereby when the adhesive attachment assembly is secured to a roofing substrate by a mechanical fastener and the release liner is removed from the self-adhering adhesive layer, the adhesive attachment assembly can adhesively bond an roofing layer overlying the adhesive attachment assembly to the roofing substrate.

2. The self-adhering adhesive attachment assembly for a roofing system according to claim 1, wherein:
the top major surface of the insulation plate has stiffening ribs to stiffen the insulation plate; and the self-adhering adhesive layer overlays the ribs to provide the adhesive attachment assembly with a top major surface that is substantially flat.

3. The self-adhering adhesive attachment assembly for a roofing system according to claim 1, wherein:
the insulation plate has a fastener-receiving hole therein for receiving a threaded or unthreaded shank portion of a mechanical fastener passing through the insulation plate to secure the adhesive attachment assembly to a roofing substrate.

4. The self-adhering adhesive attachment assembly for a roofing system according to claim 3, wherein:
there is a recess in the self-adhering adhesive layer surrounding the fastener-receiving hole for accommodating a head of a mechanical fastener securing the adhesive attachment assembly so that the head of the mechanical fastener does not protrude above a top surface of the self-adhering adhesive layer to form a thermal short between roofing layers.

5. The self-adhering adhesive attachment assembly for a roofing system according to claim 3, wherein:
the fastener-receiving hole for receiving a threaded or unthreaded shank portion of a mechanical fastener to secure the adhesive attachment assembly to a roofing substrate extends through the self-adhering adhesive layer, a portion of the self-adhering adhesive layer surrounding the fastener-receiving hole is sufficiently pliable to yield and accommodate a head of a mechanical fastener securing the adhesive attachment assembly so that the head of the mechanical fastener does not protrude above a top surface of the self-adhering adhesive layer to form a thermal short between roofing layers.

6. The self-adhering adhesive attachment assembly for a roofing system according to claim 1, wherein:
the insulation plate is a disk; the insulation plate has a fastener-receiving hole therein for receiving a threaded or unthreaded shank portion of a mechanical fastener passing through the insulation plate to secure the adhesive attachment assembly to a roofing substrate; the top major surface of the insulation plate has radially extending stiffening ribs to stiffen the insulation plate; and the self-adhering adhesive layer overlays the stiffening ribs to provide the adhesive attachment assembly with a top major surface that is substantially flat.

7. The self-adhering adhesive attachment assembly for a roofing system according to claim 6, wherein:
a portion of the insulation plate adjacent an edge of the fastener-receiving hole is reinforced.

8. The self-adhering adhesive attachment assembly for a roofing system according to claim 1, including:
a self-adhering adhesive layer overlying a bottom major surface of the insulation plate and being overlaid by a release liner.

9. The self-adhering adhesive attachment assembly for a roofing system according to claim 1, wherein:
the insulation plate is a polymer-based disk having a diameter of at least three inches; the insulation plate has a fastener-receiving hole therein for receiving a threaded or unthreaded shank portion of a mechanical fastener passing through the insulation plate to secure the adhesive attachment assembly to a roofing substrate; the top major surface of the insulation plate has radially extending stiffening ribs to stiffen the insulation plate; and the self-adhering adhesive layer overlays the stiffening ribs to provide the adhesive attachment assembly with a top major surface that is substantially flat.

10. The self-adhering adhesive attachment assembly for a roofing system according to claim 9, wherein:
there is a recess in the self-adhering adhesive layer surrounding the fastener-receiving hole for accommodating a head of a mechanical fastener securing the adhesive attachment assembly so that the head of the mechanical fastener does not protrude above a top surface of the self-adhering adhesive layer to form a thermal short between roofing layers.

11. The self-adhering adhesive attachment assembly for a roofing system according to claim 9, wherein:
the fastener-receiving hole for receiving a threaded or unthreaded shank portion of a mechanical fastener to secure the adhesive attachment assembly to a roofing substrate extends through the self-adhering adhesive layer; a portion of the self-adhering adhesive layer surrounding the fastener-receiving hole is sufficiently pliable to yield and accommodate a head of a mechanical fastener securing the adhesive attachment assembly so that the head of the mechanical fastener does not protrude above a top surface of the self-adhering adhesive layer to form a thermal short between roofing layers.

12. The self-adhering adhesive attachment assembly for a roofing system according to claim 1, wherein:
the insulation plate is a batten having a length and a width.

13. The self-adhering adhesive attachment assembly for a roofing system according to claim 12, wherein:
there are a plurality of fastener-receiving holes in the insulation plate for receiving threaded or unthreaded shank portions of mechanical fasteners passing through the insulation plate to secure the adhesive attachment assembly to a roofing substrate; and the fastener-receiving holes are longitudinally spaced apart along the length of the insulation plate.

14. The self-adhering adhesive attachment assembly for a roofing system according to claim 13, wherein:
there are recesses in the self-adhering adhesive layer surrounding each of the fastener-receiving holes for accommodating heads of mechanical fasteners securing the adhesive attachment assembly so that the heads of the mechanical fasteners do not protrude above a top surface of the self-adhering adhesive layer to form thermal shorts between roofing layers.

15. The self-adhering adhesive attachment assembly for a roofing system according to claim 13, wherein:
the plurality of fastener-receiving holes for receiving threaded or unthreaded shank portions of mechanical fasteners extend through the self-adhering adhesive layer; portions of the self-adhering adhesive layer surrounding each of the fastener-receiving holes are sufficiently pliable to yield and accommodate heads of mechanical fasteners securing the adhesive attachment assembly so that the heads of the mechanical fasteners do not protrude above a top surface of the self-adhering adhesive layer to form thermal shorts between roofing layers.

16. The self-adhering adhesive attachment assembly for a roofing system according to claim 13, wherein:
portions of the insulation plate adjacent edges of the fastener-receiving holes are reinforced.

17. The self-adhering adhesive attachment assembly for a roofing system according to claim 12, including:
a self-adhering adhesive layer overlying a bottom major surface of the insulation plate and being overlaid by a release liner.

18. The self-adhering adhesive attachment assembly for a roofing system according to claim 13, wherein:
the insulation plate is flexible and can be in roll form prior to installation.

19. The self-adhering adhesive attachment assembly for a roofing system according to claim 18, wherein:
there are recesses in the self-adhering adhesive layer surrounding each of the fastener-receiving holes for accommodating heads of mechanical fasteners securing the adhesive attachment assembly so that the heads of the mechanical fasteners do not protrude above a top surface of the self-adhering adhesive layer to form thermal shorts between roofing layers.

20. The self-adhering adhesive attachment assembly for a roofing system according to claim 18, wherein:
the plurality of fastener-receiving holes for receiving threaded or unthreaded shank portions of mechanical fasteners extend through the self-adhering adhesive layer; portions of the self-adhering adhesive layer surrounding each of the fastener-receiving holes are sufficiently pliable to yield and accommodate heads of mechanical fasteners securing the adhesive attachment assembly so that the heads of the mechanical fasteners do not protrude above a top surface of the self-adhering adhesive layer to form thermal shorts between roofing layers.

21. The self-adhering adhesive attachment assembly for a roofing system according to claim 12, wherein:
the insulation plate is a polymer-based insulation plate and has a width of at least 2.5 inches and a length of about 4 feet or more, is flexible, and can be in roll form prior to installation.

22. A roofing system, comprising:
a roofing substrate;
a self-adhering adhesive attachment assembly for securing an overlying roofing layer to the roofing substrate; the adhesive attachment assembly comprising an insulation plate; a self-adhering adhesive layer overlying a top major surface of the insulation plate for adhesively secure a roofing layer overlying the adhesive attachment assembly to the roofing substrate; and
a mechanical fastener passing through the adhesive attachment assembly and securing the adhesive attachment assembly to the roofing substrate.

23. The roofing system according to claim 22, wherein:
the roofing system includes an insulation layer;
the mechanical fastener passes through the adhesive attachment assembly and the insulation layer into the roofing substrate to secure the adhesive attachment assembly and the insulation layer by means of the adhesive attachment assembly to the roofing substrate; and
the adhesive attachment assembly has a release liner overlying the self-adhering adhesive layer overlying the top major surface of the insulation plate that can be removed to adhesively secure a roofing layer overlying the adhesive attachment assembly and the insulation layer to the roofing substrate.

24. The roofing system according to claim 23, wherein:
the top major surface of the insulation plate has stiffening ribs to stiffen the insulation plate; and the self-adhering adhesive layer overlays the ribs to provide the adhesive attachment assembly with a top major surface that is substantially flat.

25. The roofing system according to claim 23, wherein:
the insulation plate has a preformed fastener-receiving hole therein through which the threaded or unthreaded shank portion of the mechanical fastener passes to secure the insulation plate to the roofing substrate.

26. The roofing system according to claim 25, wherein:
there is a recess in the self-adhering adhesive layer surrounding the preformed fastener-receiving hole that accommodates a head of the mechanical fastener securing the adhesive attachment assembly to the roofing substrate so that the head of the mechanical fastener does not protrude above a top surface of the self-adhering adhesive layer to form a thermal short between roofing layers.

27. The roofing system according to claim 25, wherein:
the fastener-receiving hole through which the threaded or unthreaded shank portion of the mechanical fastener passes extends-through the self-adhering adhesive layer; a portion of the self-adhering adhesive layer surrounding the preformed fastener-receiving hole is sufficiently pliable to yield and yields to accommodate a head of the mechanical fastener securing the adhesive attachment assembly to the roofing substrate so that the head of the mechanical fastener does not protrude above a top surface of the self-adhering adhesive layer to form a thermal short between roofing layers.

28. The roofing system according to claim 23, wherein:
the insulation plate is a polymer-based disk; the insulation plate has a preformed fastener-receiving hole therein through which the threaded or unthreaded shank portion of the mechanical fastener passes to secure the insulation plate to the roofing substrate; the top major surface of the insulation plate has radially extending stiffening ribs to stiffen the insulation plate; and the self-adhering adhesive layer overlays the stiffening ribs to provide the adhesive attachment assembly with a top major surface that is substantially flat.

29. The roofing system according to claim 28, wherein:
a portion of the insulation plate adjacent an edge of the preformed fastener-receiving hole is reinforced.

30. The roofing system according to claim 23, wherein:
a self-adhering adhesive layer overlying a bottom major surface of the insulation plate adhesively secures the insulation plate to a top major surface of the insulation layer.

31. The roofing system according to claim 23, wherein:
the insulation plate is a disk having a diameter of at least three inches; the insulation plate has a preformed fastener-receiving hole therein through which the threaded or unthreaded shank portion of the mechanical fastener passes to secure the insulation plate to the roofing substrate; the top major surface of the insulation plate has radially extending stiffening ribs to stiffen the insulation plate; and the self-adhering adhesive layer overlays the stiffening ribs to provide the adhesive attachment assembly with a top major surface that is substantially flat.

32. The roofing system according to claim 31, wherein:
there is a recess in the self-adhering adhesive layer surrounding the preformed fastener-receiving hole that accommodates a head of the mechanical fastener securing the adhesive attachment assembly to the roofing substrate so that the head of the mechanical fastener does not protrude above a top surface of the self-adhering adhesive layer to form a thermal short between roofing layers.

33. The roofing system according to claim 31, wherein:
the fastener-receiving hole through which the threaded or unthreaded shank portion of the mechanical fastener passes extends through the self-adhering adhesive layer; a portion of the self-adhering adhesive layer surrounding the preformed fastener-receiving hole is sufficiently pliable to yield and yields to accommodate a head of the mechanical fastener securing the adhesive attachment assembly to the roofing substrate so that the head of the mechanical fastener does not protrude above a top surface of the self-adhering adhesive layer to form a thermal short between roofing layers.

34. The roofing system according to claim 22, wherein:
the roofing system includes an insulation layer;
the insulation plate is a batten having a length and a width;
the adhesive attachment assembly is secured to and the insulation layer are secured to the roofing substrate by a plurality of the mechanical fasteners passing through the adhesive attachment assembly and the insulation layer into the roofing substrate; and
the adhesive attachment assembly has a release liner overlying the self-adhering adhesive layer that can be removed to adhesively secure a roofing layer overlying the adhesive attachment assembly and the insulation layer to the roofing substrate.

35. The roofing system according to claim 34, wherein:
there are a plurality of preformed fastener-receiving holes in the insulation plate through which threaded or unthreaded shank portions of the mechanical fasteners can pass to secure the insulation plate to a roofing substrate; the preformed fastener-receiving holes are longitudinally spaced apart along the length of the insulation plate; and the threaded or unthreaded shank portions of the mechanical fasteners pass through at least some of the preformed fastener-receiving holes to secure the adhesive attachment assembly and the insulation layer to the roofing substrate.

36. The roofing system according to claim 35, wherein:
there are recesses in the self-adhering adhesive layer surrounding each of the preformed fastener-receiving holes for accommodating heads of the mechanical fasteners securing the adhesive attachment assembly to the roofing substrate so that the heads of the mechanical fasteners do not protrude above a top surface of the self-adhering adhesive layer to form thermal shorts between roofing layers.

37. The roofing system according to claim 35, wherein:
the fastener-receiving holes through which the threaded or unthreaded portion of the mechanical fasteners pass extend through the self-adhering adhesive layer; portions of the self-adhering adhesive layer surrounding each of the preformed fastener-receiving holes are sufficiently pliable to yield and accommodate heads of the mechanical fasteners securing the adhesive attachment assembly to the roofing substrate so that the heads of the mechanical fasteners do not protrude above a top surface of the self-adhering adhesive layer to form thermal shorts between roofing layers.

38. The roofing system according to claim 35, wherein:
portions of the insulation plate adjacent edges of the preformed fastener-receiving holes are reinforced.

39. The roofing system according to claim 34, wherein:
a self-adhering adhesive layer overlies a bottom major surface of the insulation plate and adhesively secures the adhesive attachment assembly to an upper surface of the insulation layer.

40. The roofing system according to claim 35, wherein:
the insulation plate is flexible and can be in roll form prior to installation.

41. The roofing system according to claim 40, wherein:
there are recesses in the self-adhering adhesive layer surrounding each of the preformed fastener-receiving holes for accommodating heads of the mechanical fasteners securing the adhesive attachment assembly to the roofing substrate so that the heads of the mechanical fasteners do not protrude above a top surface of the self-adhering adhesive layer to form thermal shorts between roofing layers.

42. The roofing system according to claim 40, wherein:
the fastener-receiving holes through which the threaded or unthreaded portions of the mechanical fasteners pass extend through the self-adhering adhesive layer; portions of the self-adhering adhesive layer surrounding each of the preformed fastener-receiving holes are sufficiently pliable to yield and accommodate heads of the mechanical fasteners securing the adhesive attachment assembly to the roofing substrate so that the heads of the mechanical fasteners do not protrude above a top surface of the self-adhering adhesive layer to form thermal shorts between roofing layers.

43. The roofing system according to claim 34, wherein:
the insulation plate is a polymer-based insulation plate and has a width of at least 2.5 inches and a length of about 4 feet or more, is flexible, and can be in roll form prior to installation.

44. The roofing system according to claim 22, wherein:
the roofing system includes a roofing layer overlying the adhesive attachment assembly;
the insulation plate of the roofing attachment assembly is a batten having an length and a width; the insulation plate is in direct contact with and secured to the roofing substrate by a plurality of the mechanical fasteners passing through the adhesive attachment assembly into the roofing substrate; and
the roofing layer overlying the adhesive attachment assembly is adhesively secured to the roofing substrate by the self-adhering adhesive layer overlying the top major surface of the insulation plate.

45. The roofing system according to claim 44, wherein:
there are a plurality of preformed fastener-receiving holes in the insulation plate through which the threaded or unthreaded shanks portions of the mechanical fasteners can pass to secure the insulation plate to a roofing substrate; the preformed fastener-receiving holes are longitudinally spaced apart along the length of the insulation plate; and the mechanical fasteners pass through at least some of the preformed fastener-receiving holes to secure the adhesive attachment assembly to the roofing substrate.

46. The roofing system according to claim 45, wherein:
there are recesses in the self-adhering adhesive layer surrounding each of the preformed fastener-receiving holes for accommodating heads of the mechanical fasteners securing the adhesive attachment assembly to the roofing substrate so that the heads of the mechanical fasteners do not protrude above a top surface of the self-adhering adhesive layer to form thermal shorts between roofing layers.

47. The roofing system according to claim 45, wherein:
the fastener-receiving holes through which the threaded or unthreaded portions of the mechanical fasteners pass extend through the self-adhering adhesive layer; portions of the self-adhering adhesive layer surrounding each of the preformed fastener-receiving holes are sufficiently pliable to yield and accommodate heads of the mechanical fasteners securing the adhesive attachment assembly to the roofing substrate so that the heads of the mechanical fasteners do not protrude above a top surface of the self-adhering adhesive layer to form thermal shorts between roofing layers.

48. The roofing system according to claim 45, wherein:
portions of the insulation plate adjacent edges of the preformed fastener-receiving holes are reinforced.

49. The roofing system according to claim 44, wherein:
a self-adhering adhesive layer overlies a bottom major surface of the insulation plate and adhesively secures the adhesive attachment assembly to an upper surface of the roofing substrate.

50. The roofing system according to claim 45, wherein:
the insulation plate is flexible and can be in roll form prior to installation.

51. The roofing system according to claim 50, wherein:
there are recesses in the self-adhering adhesive layer surrounding each of the preformed fastener-receiving holes for accommodating heads of the mechanical fasteners securing the adhesive attachment assembly to the roofing substrate so that the heads of the mechanical fasteners do not protrude above a top surface of the self-adhering adhesive layer to form thermal shorts between roofing layers.

52. The roofing system according to claim 50, wherein:
the fastener-receiving holes through which the threaded or unthreaded portions of the mechanical fasteners pass extend through the self-adhering adhesive layer; portions of the self-adhering adhesive layer surrounding each of the preformed fastener-receiving holes are sufficiently pliable to yield and accommodate heads of the mechanical fasteners securing the adhesive attachment assembly to the roofing substrate so that the heads of the mechanical fasteners do not protrude above a top surface of the self-adhering adhesive layer to form thermal shorts between roofing layers.

53. The roofing system according to claim 44, wherein:
the insulation plate is a polymer-based insulation plate and has a width of at least 2.5 inches and a length of about 4 feet or more, is flexible, and can be in roll form prior to installation.

54. The roofing system according to claim 34, wherein:
the insulation layer has an adhesive strip on an underside of the insulation layer that is directly bonded to the self-adhering adhesive layer of the adhesive attachment assembly.

55. The roofing system according to claim 22, wherein:
the roofing substrate is a roof deck.
